(19) United States
(12) Patent Application Publication
(10) Pub. No.: US 2011/0060630 A1
(43) Pub. Date: Mar. 10, 2011

(54) PROMOTIONAL MARKETING SYSTEM AND METHOD

(76) Inventor: Richard Walter, Gardnerville, NV (US)

(21) Appl. No.: 12/555,271

(22) Filed: Sep. 8, 2009

(51) Int. Cl. G06Q 30/00; G06F 15/16; G06Q 20/00; G06Q 50/00

(52) U.S. Cl. 705/14.12; 705/14.36; 709/204

(57) ABSTRACT

There is a system and method of promotional marketing, over a computerized network. The system and method include the step of providing a website module over a computerized network. The system and method also include the step of registering a user with the website module. The system and method include the step of providing a network game to the registered user. The system and method include the step of selecting a selected retail location according to information regarding the registered user. Additionally, the system and method include providing a prize for the registered user at the selected retail location.

### BACKGROUND OF THE INVENTION

1. Field of the Invention

The present invention relates to marketing systems and methods, specifically to a promotional marketing system and method.

2. Description of the Related Art

Promotional marketing is utilized to drive consumer attention to particular products or distribution channels. A promotion often involves disseminating information about a product, product line, brand, or company. It is one of the four key aspects of the marketing mix. (The other three elements are product marketing, pricing, and distribution.) Promotion is generally sub-divided into two parts: Above the line promotion: Promotion in the media (e.g. TV, radio, newspapers, Internet and Mobile Phones) in which the advertiser pays an advertising agency to place the ad Below the line promotion: all other promotion. Much of this is intended to be subtle enough for the consumer to be unaware that promotion is taking place. E.g. sponsorship, product placement, endorsements, sales promotion, merchandising, direct mail, personal selling, public relations, trade shows

The term “promotion” is usually an “in” expression used internally by the marketing company, but not normally to the public or the market—phrases like “special offer” are more common. However, with the increasing amount of inter-web advertising, there is a need for a promotional marketing system and method configured to promote in-store traffic.

Some improvements have been made in the field. Examples of references related to the present invention are described below, and the supported teachings of each reference are incorporated by reference herein:

U.S. Publication No. 2005/0027595 by Ha, Jang-Hou et al. discloses an advertising system and method using a lotto game. The advertising system provides a user with a free-of-charge lotto game in payment for the exposure of advertising messages, enables the user having a lotto-game subscription coupon manufactured by an advertiser to enjoy the free-of-charge lotto game such that it can encourage the user to aggressively view the advertising messages of the advertiser by himself or herself, resulting in the maximum advertising effect of the desired advertisement.

U.S. Publication No. 2006/0136296 by Amada discloses a system for providing direct marketing opportunities to lottery ticket retailers includes a host computer system programmed to maintain a website including separate web pages for lottery ticket retailers. The computer system stores address information for the lottery ticket retailers, receives a lottery website visitor's geographic location information and determines one or more local lottery ticket retailers located within a selected distance of the visitor's geographic location. In response to the lottery website visitor's selection of one of the local lottery ticket retailers, the system serves the webpage of the selected lottery ticket retailer for the visitor to view. The webpage of the selected lottery retailer includes promotions for a non-lottery product offered by the selected lottery ticket retailer. The lottery ticket retailers have access to webpage templates for creating their web pages.

U.S. Pat. No. 5,472,196 by Rusnak discloses a game entry pieces for a second or subsequent game are automatically generated and dispensed to a participant in a first promotional lottery based game or the like at the time the entry piece for the first game is presented for winner determination status. The benefits of the first promotional game may thus be extended to the secondary game at minimum expense. The tie-in referral system may be used to collect and distribute demographic information about the participants.

U.S. Pat. No. 6,173,267 by Cairns discloses a method for providing fulfillment in a promotional contest includes providing a card in a product package marked with an internet address and a password. The purchaser of the product contacts the internet address and inputs personal information and the password to learn if the purchaser is a winner in the contest. If the purchaser is a winner, the card is sent to the company to verify the winning status before sending the prize to the purchaser.

U.S. Pat. No. 6,292,786 by Deaton et al. discloses a method for use in marketing includes receiving at a remote location through the Internet, substantially real-time product purchase information from a retail store in conjunction with an identification code of a customer purchasing the parts at a point-of-sale. The method also includes generating at the remote location an incentive to be communicated to the identified customer and initiating communication of data relative to the incentive to the identified customer at the point-of-sale.

The inventions heretofore known suffer from a number of disadvantages which include being burdensome, being complicated, being unduly complex, being difficult to use, being ineffective, being inefficient, being limited in application, being limited in adaptation, being limited in use, and being expensive.

What is needed is a promotional marketing system and method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available promotional marketing systems and methods. Accordingly, the present invention has been developed to provide a promotional marketing system and method over a computerized network.

In one embodiment of the invention, there is a method of promotional marketing, over a computerized network. The method may include the step of providing a website module over a computerized network. The method may also include the step of registering a user with the website module, thereby creating a registered user account having information regarding the registered user. In addition, the method may include the step of providing a network game to the registered user. The method may then include the step of generating a winning event in the network game for the registered user. Then, the method may include the step of selecting a selected retail location according to information regarding the registered user. Furthermore, the method may include providing a prize for the registered user at the selected retail location. The method may also include the step of affiliating a plurality of retailers to the website module. The method may further include the step of providing the network game to an unregistered user and notifying the unregistered user of a winning event that would have been redeemable had the unregistered user already registered. Moreover, the method may include the step of generating instructions to purchase a prize from the selected retail location to give to the registered user. Then, the method may include the step of generating instructions to ship a prize to a retail location to give to the registered user. The method may also include the step of selecting a retail location regarding zip code information of the registered user.

In another embodiment of the invention, there is a promotional marketing system over a computerized network. The promotional marketing system may include a website module having a game module configured to provide a network game over a computerized network. The system may also include a registration module configured to register users to the website module. The system may further include a location selection module configured to select a retail location from information from the registration module. In addition, the system may include a prize module configured to generate a winning event in the network game to a registered user. The system may include a promotional module configured to send a prize to a retail location for the winning event for the registered user; wherein the promotional module is configured to send funds to a retail location to purchase a prize for a registered user. The system may include a network module configured to couple the website module to a network. Furthermore, the system may include a retail module configured to affiliate a plurality of retail locations to the website module. The system may also include a database module configured to store information regarding the registered user and the plurality of retail locations.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a promotional marketing system, according to one embodiment of the invention;

FIG. 2 is a sequence diagram of a promotional marketing system, according to one embodiment of the invention;

FIG. 3 is a block diagram of a website module of a promotional marketing system, according to one embodiment of the invention;

FIG. 4 is a prophetic example of a map of a location module of a promotional marketing system, according to one embodiment of the invention;

FIG. 5 is a prophetic example of a screenshot of a lottery module of a promotional marketing system, according to one embodiment of the invention;

FIG. 6 is a prophetic example of a screenshot of a prize module of a promotional marketing system, according to one embodiment of the invention;

FIG. 7 is a prophetic example of a screenshot of a prize module of a promotional marketing system, according to one embodiment of the invention; and

FIG. 8 is a sequence diagram of a promotional marketing method, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

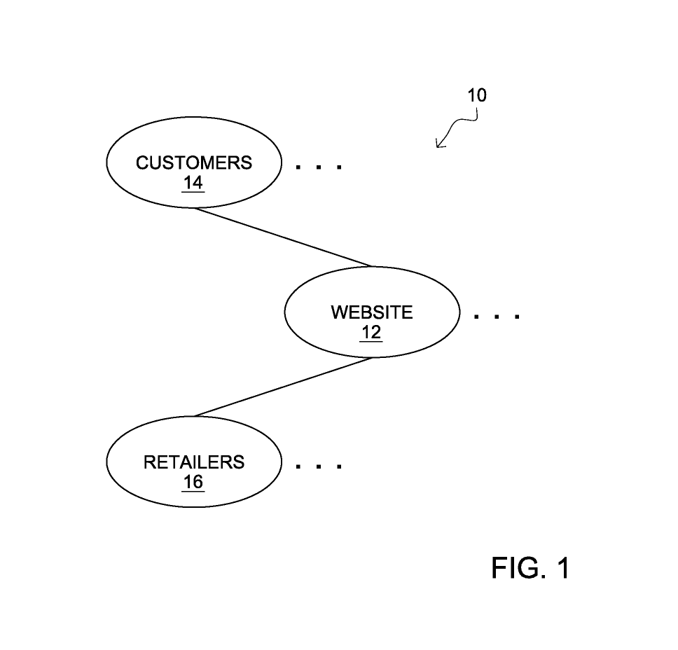

FIG. 1 is a network diagram of a promotional marketing system, according to one embodiment of the invention. There is a promotional marketing system 10 over a computerized network. As illustrated in FIG. 1, the computerized network includes a website 12 or other interface portal. The website 12 includes a network game configured to be operated over a computerized network, such as but not limited to a lottery, game of skill, wheel of chance, or slot machine type game. The website 12 is configured to enable a plurality of customers 14 to connect to the website 12 and play the network game to win a promotional prize. The website 12 is also configured to enable a plurality of retailers 16 to affiliate with the website 12 for promotional marketing. The website 12 informs a customer of winning a promotional prize, and to collect the prize at a local retail store affiliated with the website 12. The website 12 generates in-store traffic for the plurality of retailers affiliated with the website 12 by awarding a promotional prize to registered user of the network game.

The website may include typical hardware and software configured to operate a website intended to interact with a user including but not limited to one or more of the following: a server, a network card, memory storage devices, database software, operating software, website administration software, interface devices, and the like. U.S. Publication No. 2006/0136296 is incorporated by reference herein for its supporting teachings.

In operation of one embodiment of the invention, a customer connects to a website over a computerized network and plays a network game. The website generates a winning event of the network game for the customer. The website informs the customer of the winning event and where to pick up a promotional prize. The promotional prize is located at an affiliated retail store, in relative location to the customer, and the customer receives the promotional prize upon arrival, thereby creating in-store traffic from website promotional marketing.

Wherein a visitor to the site is not yet registered, the site may allow the visitor to play the game and, where the visitor wins, inform the visitor of the prize they would have received if they were registered. Accordingly, visitors will be motivated to register.

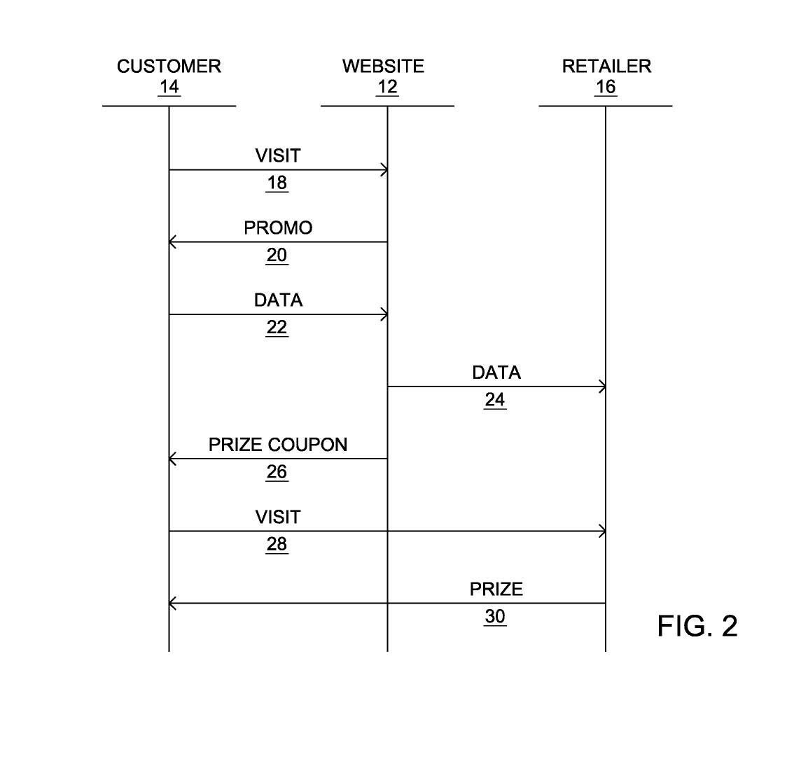

FIG. 2 is a sequence diagram of a promotional marketing system configured to be in communication with a computerized network. According to one embodiment of the invention. There is a plurality of retailers 16 affiliated with a website 12. The website 12 is configured to present a promotional network game to attract a plurality of customers 14 to visit 18 the website 12. The website 12 is configured to provide a promotional prize 20 to registered customers for winning the promotional network game. The website 12 requires the customer 14 to be registered with the website 12 to receive the promotional prize. The website 12 receives data 22 from the customer 14 and sends the data 24 to a retailer 16 having a relative location to the customer 14, to present a promotional prize to the customer, upon arrival at the retail store. The website 12 sends a prize coupon 26 to the customer, instructing the customer to pick up the prize at the designated local retail store. The customer visits 28 the retail store to receive the promotional prize and the retailer 16 presents the promotional prize to the customer 14, thereby creating in-store traffic from the website 12. In addition, the plurality of retailers 16 affiliated with the website 12 may include notification of a special sale item, an over-stocked item, a promotional coupon, etc. as the promotional prize 20 to the registered customers for winning at the promotional network game.

In operation of one embodiment of the invention, a customer visits a website and registers with the website to play a promotional network game to win a promotional prize. The customer receives a promotional message about winning a promotional prize. The website receives data regarding the customer to register with the website. The website sends data to a retailer, with a location proximate to the customer. The website then sends a prize coupon to the customer designating the location of the retailer distributing the promotional prize. The prize is either purchased by the website from the retailer or the website sends a prize to the retailer to distribute to the customer. The customer visits the retailer and picks up the promotional prize.

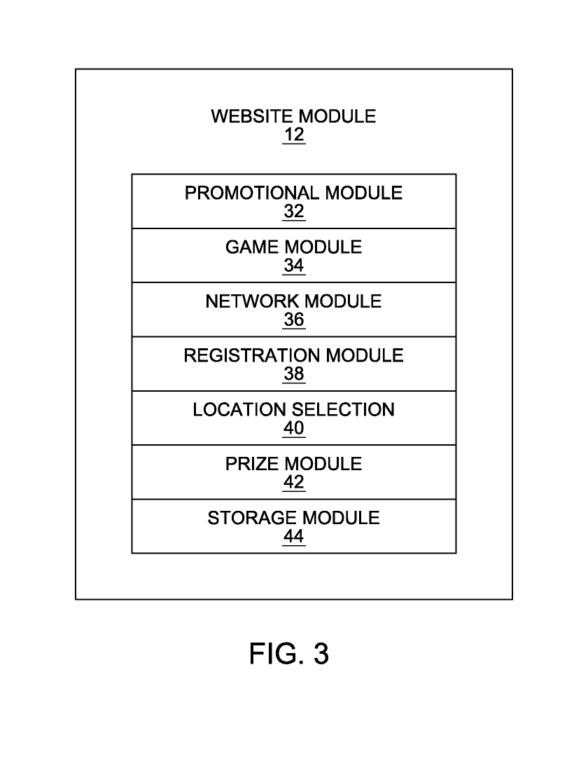

FIG. 3 is a block diagram of a website module of a promotional marketing system, according to one embodiment of the invention. There is a promotional marketing system over a computerized network including a website module 12. The >website module 12 includes a game module 34 configured to provide a network game over a computerized network. The network game may be but not limited to a lottery game, a card game, a chance game, a guessing game, a musical game, etc. The website module 12 also includes a registration module 38 configured to register users to the website module 12. The website module 12 includes a location selection module configured to select a retail location from information from the registration module. In addition, the website module 12 includes a prize module 42 configured to generate a winning event in the network game to a registered user. The website module 12 also includes a promotional module 32 configured to send a prize to a retail location for the winning event for the registered user; wherein the promotional module 32 is configured to send funds to a retail location to purchase a prize for a registered user. The website module includes a network module 36 configured to couple the website module to a network. Furthermore, the website module 12 includes a storage module 44 configured to store information regarding the registered user and the plurality of retail locations.

In operation of one embodiment of the invention, the website module is configured to present a network game to a customer. The customer plays the network game, and if the customer wins and is a registered customer with the website, then the website presents a promotional coupon to the customer to receive a free promotional prize. The promotional prize is located at a local retail store for the registered customer to pick up.

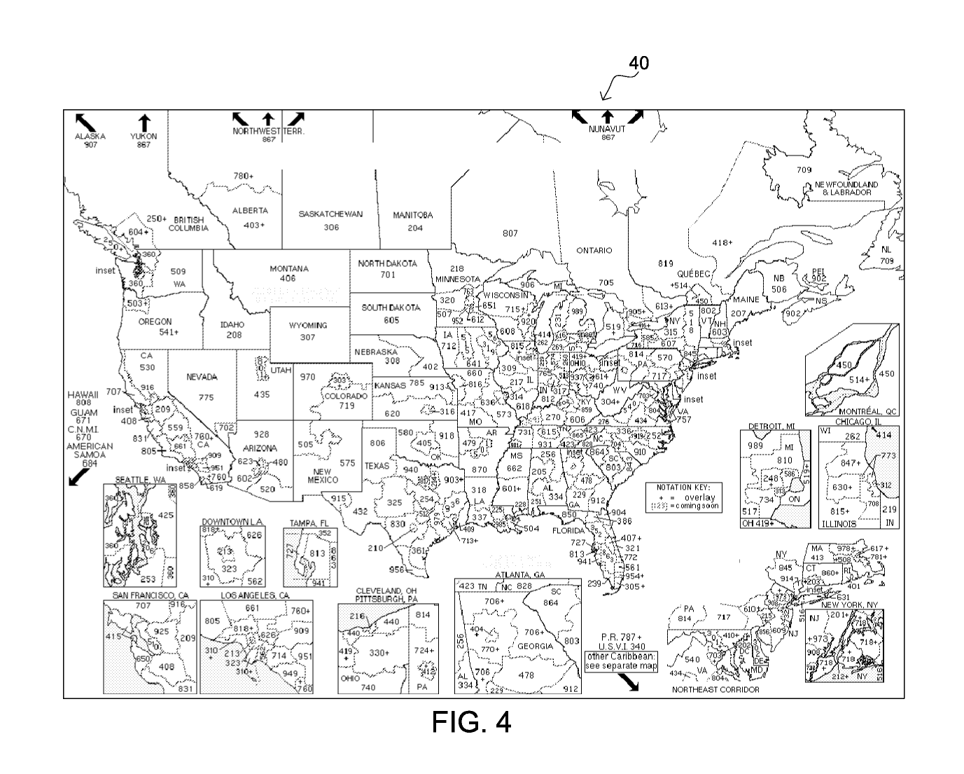

FIG. 4 is a prophetic example of a map of a location module of a promotional marketing system, according to one embodiment of the invention. The location module 40 is configured to select, from a plurality of retailers, one that is closest to the customer, depending on the address given by the customer in the registration module. As illustrated in FIG. 4, the location module 40 is configured to select a retailer depending upon a location characteristic. Non-limiting examples of a location characteristic may be: zip code, area code, state, city, country, demographic data, etc. and still perform its intended function.

In operation of one embodiment of the invention, the website module references the location module to send the registered customer a promotional prize coupon for a promotional prize at the nearest local retailer. The location module uses location characteristics or parameters relative to the customer's location to determine which retailer the customer visits to receive the promotional prize.

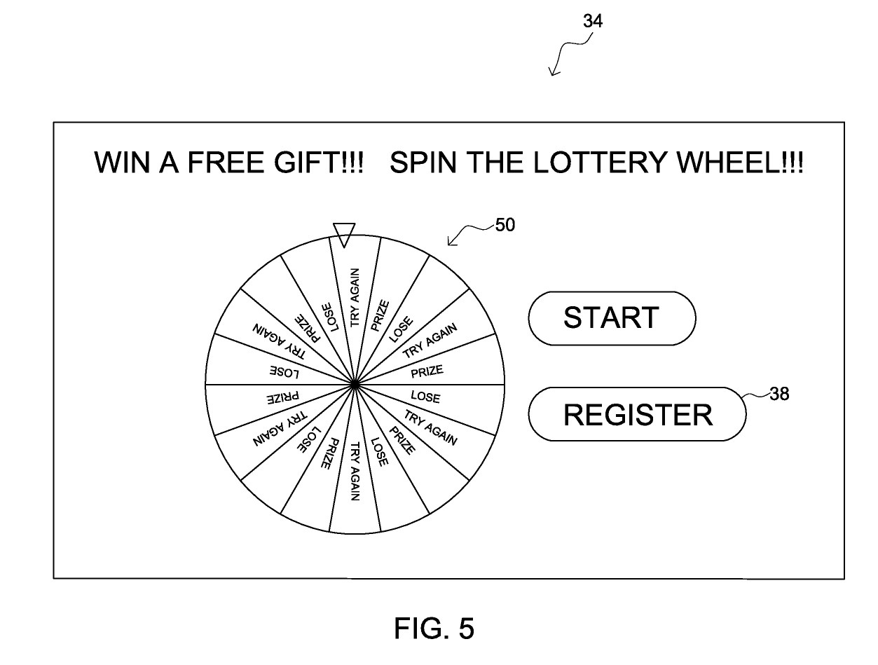

FIG. 5 is a prophetic example of a screenshot of a lottery module of a promotional marketing system, according to one embodiment of the invention. There is a promotional marketing system over a computerized network. The promotional marketing system includes a website module having a game module 34 configured to provide a network game 50 over a computerized network. The system also includes a registration module 38 configured to register users to the website module. In addition, the system includes a prize module configured to generate a winning event in the network game 50 to a registered user.

In operation of one embodiment of the invention, a customer visits the website and plays a network game over a computerized network. The customer starts the network game and either wins the network game or does not. If the customer wins the network game, the website will ask the customer if the customer is a registered user of the website. If the customer is a registered user of the website, then the website displays a promotional prize coupon to the customer. If the customer is not a registered user of the website, the website will display a message stating that if the customer was a registered user they would have won a promotional prize. The website includes a registration module for customers to register with the website.

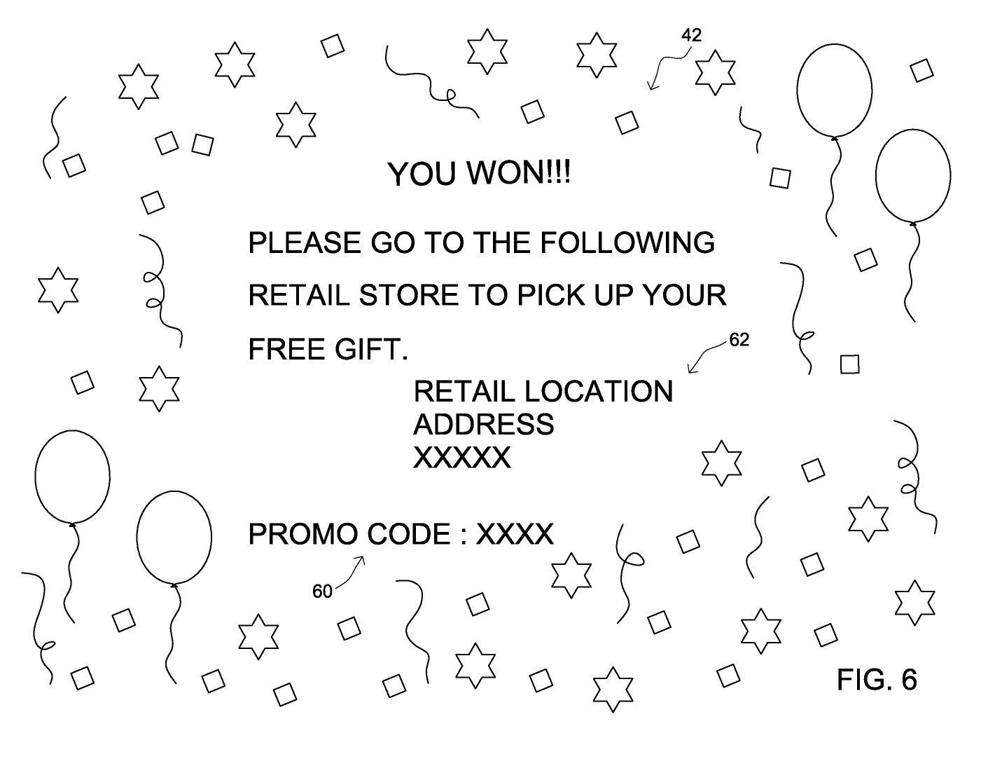

FIG. 6 is a prophetic example of a screenshot of a prize module of a promotional marketing system, according to one embodiment of the invention. There is a promotional marketing system over a computerized network. The promotional marketing system includes a website module having a game module configured to provide a network game over a computerized network. The system includes a prize module 42 configured to generate a winning event in the network game to a registered user. The prize module 42 is configured to send a registered user confirmation of winning a promotional prize designating the location of the promotional prize. The prize module also includes a promo code 60 and a retail location 62 for the registered user to receive the promotional prize.

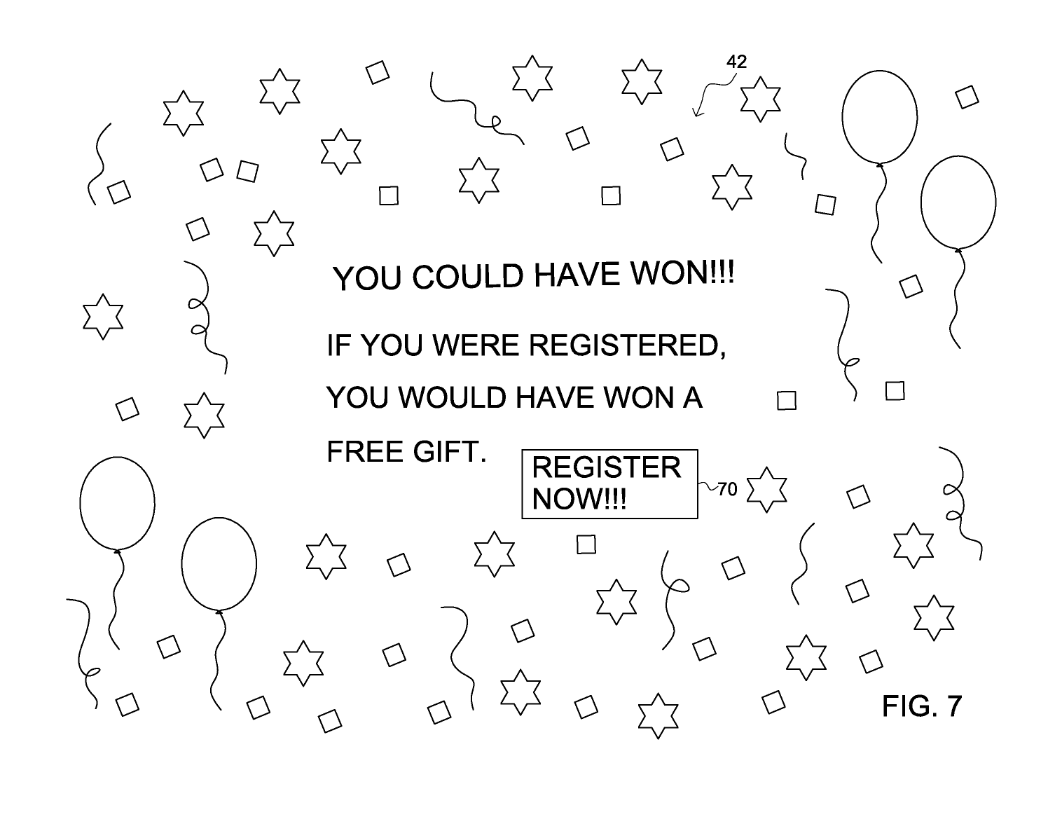

FIG. 7 is a prophetic example of a screenshot of a prize module of a promotional marketing system, according to one embodiment of the invention. There is a promotional marketing system over a computerized network. The promotional marketing system includes a website module having a game module configured to provide a network game over a computerized network. The system includes a prize module 42 configured to generate a winning event in the network game to an unregistered user. The unregistered user receives a notice and a chance to register as a registered user 70 to the website.

In operation of one embodiment of the invention, an unregistered user a customer visits the website and plays a network game over a computerized network. The customer starts the network game and either wins the network game or does not. If the customer wins the network game, the website will ask the customer if the customer is a registered user of the website. If the customer is a registered user of the website, then the website displays a promotional prize coupon to the customer. If the customer is not a registered user of the website, the website will display a message stating that if the customer was a registered user they would have won a promotional prize. The website includes a registration module for customers to register with the website.

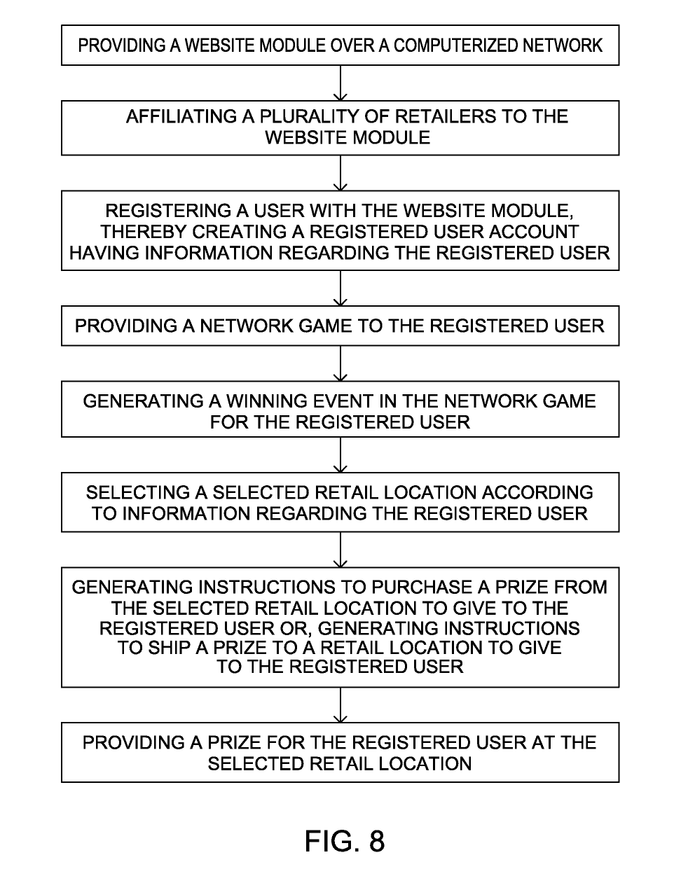

FIG. 8 illustrate a sequence diagram of a promotional marketing method, according to one embodiment of the invention. There is a method of promotional marketing over a computerized network. The method includes the step of providing a website module over a computerized network. The method includes affiliating a plurality of retailers to the website module. The method also includes the step of registering a user with the website module, thereby creating a registered user account having information regarding the registered user. In addition, the method includes the step of providing a network game to the registered user. The method then includes the step of generating a winning event in the network game for the registered user. Then, the method includes the step of generating instructions to purchase a promotional prize from a selected retail location or generating instructions to ship a promotional prize to a selected retail location for the customer to pick up. The method also includes the step of selecting a selected retail location according to information regarding the registered user. Furthermore, the method includes providing a prize for the registered user at the selected retail location.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the drawings illustrate particular games/prizes, it is understood that the games and prizes involved are plethoric and may be provided in a great number of combinations.

Additionally, although the figures illustrate particular interfaces and communications between modules and participants, it is understood that additional/alternative communications may be present in varying embodiments.

It is also envisioned that an embodiment of the invention may operate over a network other than the internet.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of promotional marketing, over a computerized network, comprising the steps of:
a) providing a website module over a computerized network;
b) registering a user with the website module, thereby creating a registered user account having information regarding the registered user;
c) providing a network game to the registered user;
d) generating a winning event in the network game for the registered user;
e) selecting a selected retail location according to information regarding the registered user; and
f) providing a prize for the registered user at the selected retail location.

2. The method of claim 1 further comprising the step of affiliating a plurality of retailers to the website module.

3. The method of claim 1 further comprising the step of providing the network game to an unregistered user and notifying the unregistered user of a winning event that would have been redeemable had the unregistered user already registered.

4. The method of claim 1 further comprising the step of generating instructions to purchase a prize from the selected retail location to give to the registered user.

5. The method of claim 1 further comprising the step of generating instructions to ship a prize to a retail location to give to the registered user.

6. The method of claim 1 further comprising the step of selecting a retail location regarding zip code information of the registered user.

7. A promotional marketing system over a computerized network, comprising:
a) a website module, including:
a1) a game module configured to provide a network game over a computerized network;
a2) a registration module configured to register users to the website module;
a3) a location selection module configured to select a retail location from information from the registration module;
a4) a prize module configured to generate a winning event in the network game to a registered user; and
a5) a promotional module configured to send a prize to a retail location for the winning event for the registered user; and
b) a network module configured to couple the website module to a network.

8. The marketing system of claim 7 further comprising a retail module configured to affiliate a plurality of retail locations to the website module.

9. The marketing system of claim 7 further comprising a database module configured to store information regarding the registered user and the plurality of retail locations.

10. The marketing system of claim 7 wherein the promotional module is configured to send funds to a retail location to purchase a prize for a registered user.

11. The marketing system of claim 7, wherein the prize module is configured to send a consolation message to an unregistered user of a winning event in the network game.

12. The marketing system of claim 7, wherein the promotional module is configured to send a prize coupon to the registered user after a winning event of the network game.

13. A promotional marketing system over a computerized network, comprising:
a) a retail module configured to affiliate a plurality of retail locations to the website module
b) a website module, including:
b1) a game module configured to provide a network game over a computerized network;
b2) a registration module configured to register users to the website module;
b3) a location selection module configured to select a retail location from information from the registration module;
b4) a prize module configured to generate a winning event in the network game to a registered user; and
b5) a promotional module configured to send a prize to a retail location for the winning event for the registered user; and
c) a network module configured to couple the website module to a network.

14. The marketing system of claim 13 further comprising a database module configured to store information regarding the registered user and the plurality of retail locations.

15. The marketing system of claim 14, wherein the promotional module is configured to send funds to a retail location to purchase a prize for a registered user.

16. The marketing system of claim 15, wherein the prize module is configured to send a consolation message to an unregistered user of a winning event in the network game.

17. The marketing system of claim 16, wherein the network game is a lottery game.

18. The marketing system of claim 17, wherein the registration module is configured to register a location of the user.

19. The marketing system of claim 18, wherein the promotional module is configured to send a prize coupon to the registered user after a winning event of the network game.

20. The marketing system of claim 19, wherein the location module selects a retailer closest to the location of the registered user.
